(19) United States
(12) Patent Application Publication
(10) Pub. No.: US 2023/0288298 A1
(43) Pub. Date: Sep. 14, 2023

(54) Gas Monitoring Systems and Methods

(71) Applicant: CAST Environmental, LLC, West Conshohocken, PA (US)

(72) Inventor: Marcelo Cassani, Bryn Mawr, PA (US)

(21) Appl. No.: 18/015,470

(22) PCT Filed: Jul. 12, 2021
(86) PCT No.: PCT/US21/41220

§ 371 Date: Jan. 10, 2023

Related U.S. Application Data
(60) Provisional application No. 63/051,501, filed on Jul. 14, 2020.

(51) Int. Cl. G01N 1/22

(52) U.S. Cl. CPC G01N 1/2247; G01N 1/2202; G01N 2001/2223

(57) ABSTRACT

Autonomous systems and methods to measure contaminants in a contaminated gas stream and provide feedback to a control system to reduce the unit usage when contaminants are present in specific detectable quantities or in quantities lower than the anticipated limits are disclosed. Disclosed embodiments monitor a gas stream input and/or input and output continuously or at predefined intervals adjustable by the user on odor control or air emission treatment equipment. Disclosed monitoring systems clean a gas sensor probe/detector by cycling the input stream to the sensor between a contaminated gas sample and cleaning air. Retrofittable monitoring system kits are also disclosed to achieve advantages described herein with previously installed monitoring and treatment systems.

### RELATED APPLICATIONS

The present application claims priority to U.S. Provisional Application No. 63/051,501, filed Jul. 14, 2020, entitled “Continuous Monitoring Odor Control Systems and Methods,” which is incorporated by reference herein in its entirety.

### FIELD

The present disclosure generally relates to fields of monitoring and treatment of contaminated gases, including foul air. In particular, the present disclosure is directed to systems and methods for gas monitoring and for continuous monitoring and treatment of contaminated gas streams.

### BACKGROUND

Wastewater infrastructure, composting operations, industrial manufacturing and many other processes and installations can release a wide variety of contaminants to the air. These by-products can cause a variety of adverse effects, such as adverse health effects, odor production, and corrosion. Community odors remain one of the top three complaints to air quality regulators and government bodies around the U.S. and internationally. Most of all air pollution complaints are odor related.

Odors from a facility such as a wastewater treatment plant and/or related collection system, can negatively affect a surrounding community. These odors commonly lead to nuisance complaints. Estimating the effects of odors from a facility often requires laboratory odor testing. In order to accomplish this testing conventionally, air samples from the facility are collected and shipped overnight to an odor-testing laboratory. In some cases a gas sensor with a datalogger that will record the information during a certain period that is put in place is used. After the results are collected and analyzed, engineers and city managers can formulate a plan to properly address the issue.

Wastewater streams generally have variable flow and so too the concentration of odorous compounds. The flow can vary by the day of the week and hour of the day. Waste-water flow normally peaks early in the morning when people prepare for work/school, and during the night when they return to their homes. Weekends can be highly variable. Outside influences, such as storm events and snow melt can also affect the load on a wastewater treatment system.

Wastewater treatment processes release air contaminants as a byproduct of collecting, mixing, processing, transferring and treating wastewater. In wastewater treatment a common air contaminant is hydrogen sulfide (H2S). However, a wide variety of industrial processes release a wide variety of gaseous air contaminants that can present odor or more serious health risks.

Contaminant gasses such as H2S are typically monitored by specialized testing equipment that use a sensor to capture, record, and data log the level in parts per million (ppm). Electrochemical sensors are typically used. Such sensors work well for periodic checks or monitoring a space of the sudden appearance of a contaminant gas, but they are not well-suited to long term or continuous monitoring of gas streams that continually contain some amount of contaminant gas. If such a sensor is exposed continuously for an extended period, it can ‘saturate.’ In this state, products of the oxidation reaction are not able to ‘escape’ from the sensor in time for fresh gas to enter. This essentially blocks the active sites of the electrode and the sensor sensitivity will reduce (ultimately to zero). If a sensor is returned into clean air after saturation has occurred, it will usually recover. However, this recovery may take many hours (depending on the severity of saturation).

Continuous monitoring has at times been attempted by cycling two or more sensors in and out of the contaminated gas stream, such that each sensor is only exposed to the gas contaminant for a fraction of the time, and in theory recovering while out of the contaminated gas stream. However, in practice, it can be difficult to predict the time it will take for a specific sensor to reach saturation. Time to saturation depends on several factors, including sensor type, gas concentration, flow rate, gas delivery design, temperature and humidity. Additionally, the rate of saturation depends on the gas concentration. If the gas concentration exposed to the sensor is small compared to its range, then it will take longer to saturate. In some cases, sensors with larger ranges have been able to cope with continuous exposure to small amounts of gas for many months. Such systems have many drawbacks and are not widely adopted.

Poor energy efficiency is another drawback of many systems that attempt continuous monitoring of contaminant gasses because such systems require continuous operation, which may require pumps and fans to operate continuously. Every year much of the energy consumed is wasted through transmission, heat loss and inefficient technology, costing families and businesses money and leading to increased carbon footprint.

Energy efficiency is one of the easiest and most cost-effective ways to combat climate change, clean the air we breathe, improve the competitiveness of our businesses and reduce energy costs for consumers. However, it is impossible to be energy efficient in a variable process without a real time and continuous measurement able to retrofit the control system of the process.

### SUMMARY

Embodiments disclosed herein include gas monitoring systems comprising a self-cleaning and/or decontamination system with the objective to enhance the service life of a measuring gas sensor.

In one implementation, the present disclosure is directed to a gas monitoring system. The system includes a gas command circuitry and a decision logic configured to perform at least one of self-cleaning or decontamination for an electrochemical gas sensor communicating with the gas command circuitry.

In another implementation, the present disclosure is directed to a gas monitoring system for continuous gas contaminant monitoring in a gas treatment system having a gas treatment unit communicating with a contaminated gas source and outputting a treated gas. The monitoring system includes at least first and second sample gas streams receiving a gas sample from at least one of the contaminated gas source and the treated gas output; at least first and second selector valves, each communicating with one the gas sample stream, the selector valves each configured to select between the gas sample stream and an air stream to provide at least first and second sample input streams each selectively comprising the gas sample or air; and at least first and second gas sensors, each receiving one the sample input stream; and a decision logic configured to control the selector valves to switch the sample input stream from gas sample to the air after a first parameter is met and to switch from the air to the gas sample after a second parameter is met.

In yet another implementation, the present disclosure is directed to a gas monitoring method, which includes providing an input stream to a gas sensor; selectively switching the input stream between a gas sample stream and a cleaning air stream, wherein the input stream is switched from the gas sample stream to the cleaning air stream based on a first parameter, and the input stream is switched from the cleaning air stream to the gas sample stream based on a second parameter; detecting a gas contaminant in the gas sample stream with the gas sensor; and cleaning the gas sensor with the cleaning air stream.

In still another implementation, the present disclosure is directed to a gas sensor cleaning kit for retrofitting an existing gas monitoring system having a gas sensor receiving a sample input stream from a contaminated gas source of a gas. The kit includes a selector valve configured to be disposed in the sample stream to selectively switch between the gas sample stream and a cleaning air stream; and a decision logic configured to switch the selector valve from the gas sample input stream to the air input stream after a first parameter is met and to switch the air input stream to the gas sample input stream after a second parameter is met.

### BRIEF DESCRIPTION OF DRAWINGS

For the purpose of illustrating the disclosure, the drawings show aspects of one or more embodiments of the disclosure. However, it should be understood that the present disclosure is not limited to the precise arrangements and instrumentalities shown in the drawings, wherein:

FIG. 1 is a schematic depiction of an embodiment of a system and method for monitoring contaminated gas streams according to the present disclosure.

FIG. 2 is a flow diagram illustrating a decision logic for control of systems described herein.

FIGS. 3, 4, 5 and 6 are schematic depictions of embodiments of systems and methods for treatment of contaminated gas streams utilizing contaminated gas stream monitoring systems and methods according to the present disclosure.

### DETAILED DESCRIPTION

Embodiments disclosed herein provide autonomous systems and methods to measure contaminants in a contaminated gas stream and provide feedback to a control system to reduce the unit usage when contaminants are present in specific detectable quantities or in quantities lower than the anticipated limits. This unload of the equipment not only extends its service life, will make it more efficient by consuming less power thus making the system energy efficient, reducing operational cost and saving taxpayers money.

Disclosed embodiments monitor a gas stream input and/or input and output continuously or at predefined intervals adjustable by the user on odor control or air emission treatment equipment (new or existing). The predefined intervals may be at any time interval, and can be made effectively continuous by ganging together multiple sensors, each with its own inputs from the source air stream and ambient air for recovery. In such a multi-sensor arrangement, continuous sensing is possible by sequentially switching the air source to be tested to different sensors while switching the previously active sensor to ambient air input for recovery as described below.

Embodiments disclosed herein are configured to measure the contaminants in the input air streams at user-selected intervals to allow the odor control or air emission treatment system to reduce power consumption according to variable inlet contaminant concentrations. Disclosed monitoring systems are also designed to clean a gas sensor probe/detector once a reading is taken to avoid damage, deterioration or saturation due to continuous exposure. In other embodiments, a retrofittable monitoring system kit is provided to achieve advantages described herein with previously installed monitoring and treatment systems.

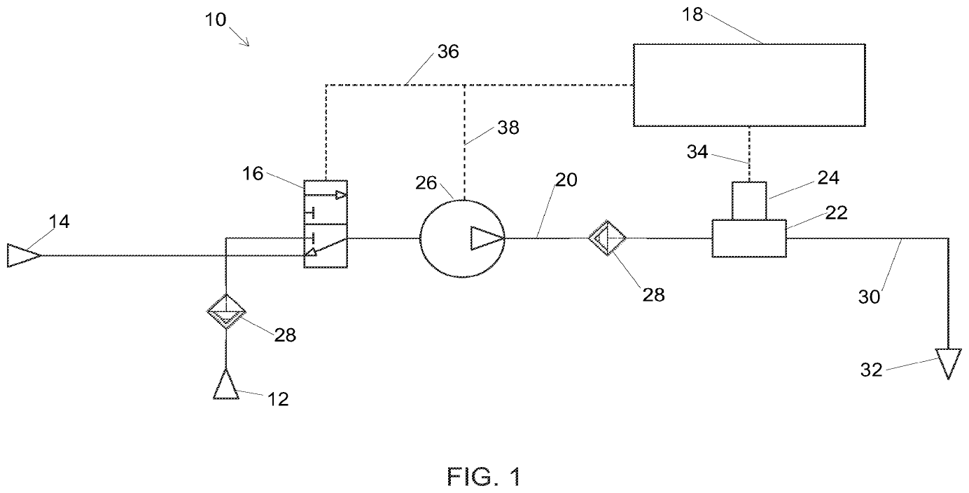

An illustrative embodiment of a monitoring system according to the present disclosure is schematically depicted in FIG. 1. As shown therein, schematic system 10 samples a contaminated gas source via sampling inlet 12 and receives atmospheric air (clean air) via air intake 14. Selector valve 16, under control of decision logic 18, selectively delivers as input stream 20 either the contaminated gas sample or atmospheric air downstream to measuring chamber 22 wherein a detection element of gas sensor 24 is disposed. Pump 26 delivers input stream 20 to measuring chamber 22 under pressure. Optionally, filters and/or water separators 28 may be disposed at the sampling inlet 12 and/or in input stream 20. Selector valve 16 is exemplified in this disclosure as three-way, two-position valve, but many different valve configurations may be employed by persons skilled in the art based on the teachings contained herein. In other embodiments, the function of the selector valve may be accomplished by other valve types, such as multiple shut off valves and associated piping to enable closing flow from one source and opening flow from another source. Selector valve as used herein thus refers to any arrangement of valving and/or valving and piping that permits controlled switching between at least one gas sample source and at least one air source.

After exiting measuring chamber 22, sampled stream 30 is exhausted at exhaust outlet 32. Exhaust may be back to atmosphere or return sampled stream 30 back to the contaminated gas source. Sensor 24 is positioned to detect contaminants in input stream 20 within measuring chamber 22. Sensor 24 produces an output signal indicative of the measured contaminants in accordance with sensor setup, which signal is delivered to decision logic 18 via communication link 34. After decision logic 18 receives the sensor signal via communication link 34, a control signal is delivered to selector valve 16 via communication link 36 switching the selector valve to change input stream 20 to atmospheric (clean) air via air intake 14. Delivery of atmospheric air to measuring chamber 22 allows self-cleaning and decontamination of sensor 24.

In some embodiments, it may be desirable to additionally provide a control signal to pump 26 with decision logic 18. For example, in some systems where gas to be sampled is provided at a relatively high pressure, pump 26 may be needed only to ensure sufficient pressure in atmospheric air supplied from air intake 14. In such systems, pump 26 may be cycled off by decision logic 18 when not needed. An additional communication link 38 may be provided for communication with pump 26.

Gas sensors used in embodiments of the present disclosure may comprise any suitable type of commercially available gas sensor as may be selected by persons skilled in the art based on the teachings of the present disclosure. In particular, embodiments described herein are well-suited for use with electrochemical sensor systems for detection of gases such as Carbon Monoxide (CO), Oxygen (O2), Hydrogen Sulfide (H2S), Sulfur Dioxide (SO2), Ammonia (NH3), Chlorine (Cl2), Hydrogen Fluoride (HF) among others.

Decision logic 18 comprises a set of instructions for determining timing and period of selection between atmospheric air and contaminated gas sample as inputs to measuring chamber 22, and may include as parameters preset or user-defined timing parameters and signal information from sensor 24. In some embodiments, decision logic 18 can be embodied in a circuit, or executed by a data processing device comprised of components such as one or more processors, memory, user interface and application interface. Alternatively, decision logic 18 may be embodied in a programmable logic controller (PLC) with both analog and digital inputs and outputs, a communications module, and a human machine interface (HMI) with a touch screen that allows the system to interact with the user. Communication links as described herein may be wired or wireless, or a combination of both and may be executed with conventional communications protocols such as LAN, WLA, WIFI, Bluetooth, etc. Controllers may include communication modules configured to communicate information to the user in many different modes such as modem or gateway to send system information to a cloud-based system, a SCADA, and/or email or text messages of alarm conditions to selected personnel.

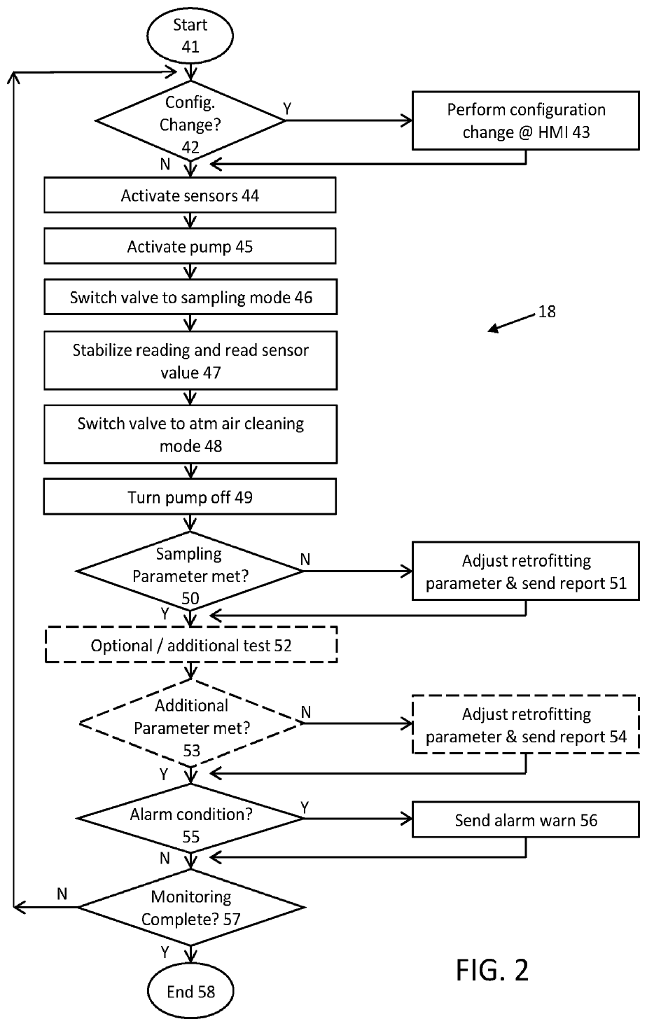

An exemplary embodiment of decision logic 18 is illustrated in FIG. 2. After initialization 41, system configuration parameters are checked 42. If the system configuration does not meet user set parameters, system configuration is changed either automatically or via the HMI 43. Alternatively, if the user needs or wants to change system configuration parameters, it can be done via the HMI 43 at this stage. If no changes are made or once changes are complete, the algorithm will continue to the next step. Examples of system configuration parameters include sampling time, setpoints against which measurements are compared, user specific reports and/or alarms, and other optional parameters as described further below.

After the system configuration is set, sensors are activated 44, the pump (where present) is activated 45, and the selector valve is switched to gas sample mode 46 to deliver the gas sample stream to the measuring chamber. After a defined time typically based on system configuration (configuration factors such as type and size of conducting tubing, pump parameters and distance from sampling inlet to measuring chamber), the sample of contaminated gas will reach and flow through the measuring chamber for detection by the sensor 47. After the sensor reading stabilizes and the measured contaminant value determined, the selector valve is switched to atmospheric air putting the system into cleaning mode 48. In some embodiments, sensing time 47 may be a predefined time period based on parameters such as sensor type/performance and user preferences in specific applications, or, alternatively, sensing time may be dynamic based on setpoint values of measured contaminants.

In cleaning mode 48, the pump delivers fresh air to allow the sensor to be cleaned and decontaminated. The decontamination time will typically be a preset time period defined by the user based on the sensor type and specifications. In some embodiments, output from additional sensors indicating the main sensor state may be dynamically incorporated into the determination of decontamination time. After the decontamination time, the pump is turned off 49. Typically, system components will be maintained in an off state until the next monitoring cycle. Particularly in long sampling cycles turning the system off is a good energy saving practice facilitated by embodiments disclosed herein.

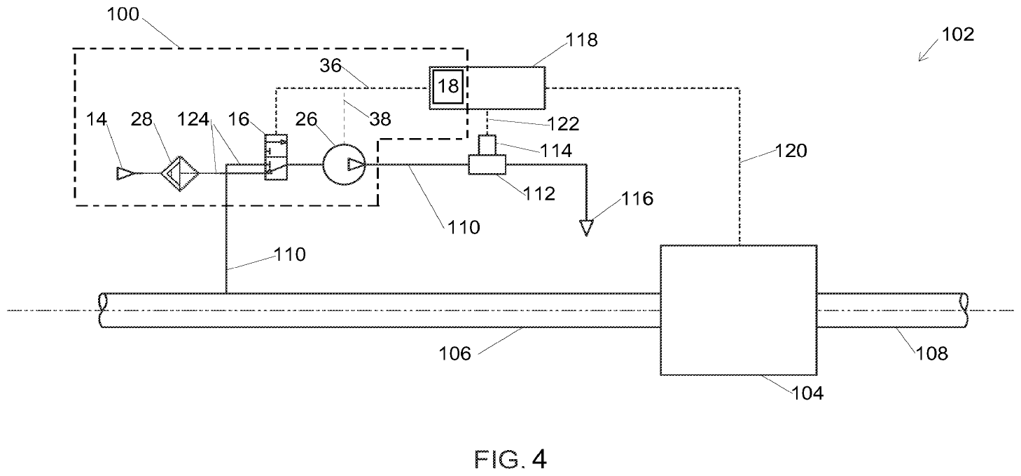

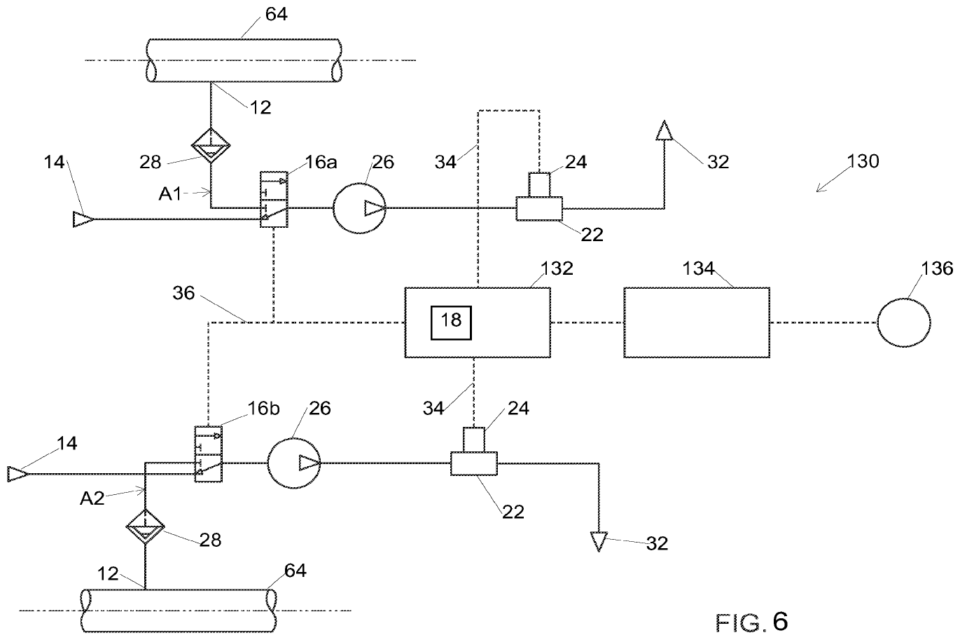

In a simplified embodiment, after measuring contaminants in the gas sample stream, decision logic 18 will send a signal to the machine or process control and jump to the alarm condition check. In some more advanced alternative embodiments (e.g., as shown in FIGS. 4 and 6), the measuring and monitoring system can be independent from the machine or process control (especially when retrofitting units already existing and installed in the field). In such embodiments, after measuring contaminants in the gas stream, the decision logic will check if the parameter level is according to the preset level 50. If this check indicates a correct parameter, process flow advances to the next step, but if not, a signal is sent back to the machine controller to adjust 51 the process since the contaminant level is over an expected level.

Optional or additional checks of different contaminants 52, 53 can be done in processes with more than one contaminant or otherwise where several measurements must be performed to identify the additional contaminants. Overall, the process with optional or additional checks is generally the same in terms of the cycle, after the first contaminant measurement the system will check for the second contaminant, will determine the level of the second contaminant, and will send a signal 54 according to the presets in a process as described before. After the measuring cycle, an alarm check is performed 55 and if there is any specified alarm condition detected, an alarm warning is sent 56. The determination of whether monitoring is complete 57 may be based on user-set preferences such as time or a specified number of measuring cycles. When the user-set preference for completion of monitoring is met, the control sequence ends 58 until re-initiated.

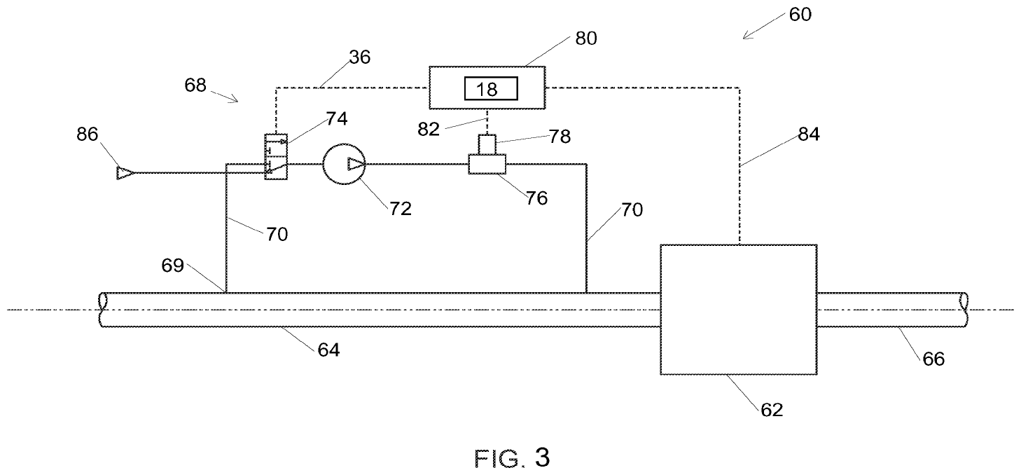

FIG. 3 illustrates an exemplary embodiment with a monitoring system integrated into a gas treatment system in accordance with the present disclosure. As shown therein, gas treatment system 60 includes treatment unit 62 receiving a gas stream to be treated via source piping 64, outlet piping 66 for the treated gas and monitoring system 68. In this embodiment, a sample from the gas stream to be treated is pulled from source piping 64 at sample inlet 69 through tubing 70 by pump 72 to selector valve 74 at any pressure either positive or negative. In a negative pressure system, the pump will pull gas from the pipe 64, to be sent to the sampling chamber 76. In a positive pressure system, the pump will act as a dosing pump to send limited amount of gas to the measuring chamber so it is not overflooded and the sensor does not saturate before a measurement can be taken. Once the sample gas reaches pump 72, it will push the gas through the tubing to reach measuring chamber 76 and then finally it exhausts sampled gas back to gas treatment system source piping 64.

Measuring chamber 76 is the point of the system where a detecting element of gas sensor 78 contacts the gas sample stream to generate an electric signal delivered to controller 80 via communication link 82 proportional to contaminants detected within the sampled gas stream. In this embodiment, controller 80 contains decision logic 18 as described above. Controller 80 delivers a control signal to gas treatment system 60 to modulate treatment control based on level of sampled contaminants via communication link 84. One example of a gas treatment system is disclosed in U.S. patent publication No. 2020/0406189A1, entitled “Multi-Stage Treatment System and Methods for Removal of Target Vapor Compounds from Contaminated Air Streams,” which is incorporated by reference herein in its entirety. Controller 80 may comprise one or more processors, memory, user interface and application interface. Controller 80 further may be configured to execute control algorithms stored in memory based on inputs from the sensor probe and other inputs as may be required by persons of ordinary skill based on the teachings contained herein. After controller 80 takes the measurement of the contaminant, based on decision logic 18 controller 80 switches selector valve 74, closing the intake of contaminated gas from sampling inlet 69 to switch to atmospheric air from air intake 86 to self-clean and decontaminate gas sensor 78.

FIG. 4 illustrates a further alternative embodiment in which gas monitor control kit 100 is used to retrofit an existing gas treatment system 102. (Components of gas monitor control kit 100 are delineated within the dashed box in FIG. 4.) In this embodiment, existing gas treatment system 102 includes gas treatment unit 104, supply piping 106 and outlet piping 108 substantially as described above in connection with the embodiment of FIG. 3. Existing gas treatment system 102 also includes a simple gas monitor system comprised of sample tube 110 delivering the sampled gas stream to measuring chamber 112, containing the detector element of gas sensor 114, and thereafter exhausting the sampled gas stream to atmosphere at outlet 116. Contaminant levels as detected by gas sensor 114 are received by system controller 118 and used to modulate operation of gas treatment unit 104 via communication links 120 and 122.

Gas monitor control kit 100 includes many of the same components as described above in connection with FIG. 1. Decision logic 18 when installed in and executed by controller 118 controls the operation of selector valve 16 and pump 26 via communication links 36 and 38. Kit 100 also optionally includes filter and/or water separator 28 to protect gas sensor 114 and additional tubing 124 to mate with existing system tubing 110 and to connect atmospheric air intake 14. Once installed in existing gas treatment system 102, gas control monitor kit 100 operates to modulate gas delivery to measuring chamber 112 between the gas sample and atmospheric air as described above in connection with the embodiments shown if FIGS. 1-3. In some embodiments of kit 100, decision logic 18 may be stored on a computer readable medium and transferred to storage module of controller 118 for execution by a processing device of the controller.

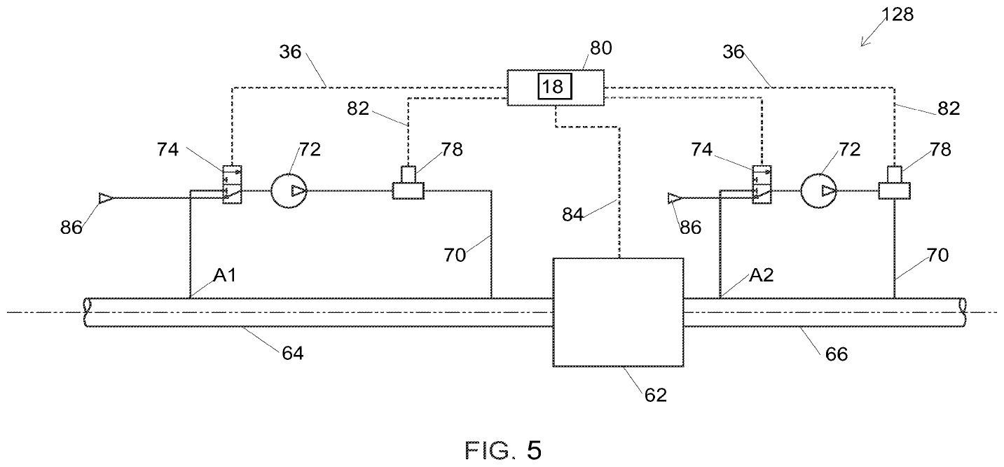

The teachings of the present disclosure can be used in many other applications or embodiments. For example, as depicted in FIGS. 5 and 6, systems according to the present disclosure may be configured to sample two separate sources of contaminated gas A1 and A2. In one embodiment, shown in FIG. 5, sources A1 and A2 may correspond to inlet and outlet air streams of air treatment system 128, allowing the air treatment system to ramp up or down according to performance and/or requirements based on measured contaminant concentration in, out and/or differential concentrations. For example, in a system with components such as shown in FIG. 6, employing VFD drive 134 and motor(s) 136, process controller 132 may send a signal to ramp up or down the speed of the process according to the contaminant removal efficiency. This variation of the speed according to contaminant concentration makes a steady process with variable loads into a variable speed process that allows the user to save energy thus money when the contaminant load is low. Other components of air treatment system 128 are as described above in connection with system 60, shown in FIG. 3. Applications like this may use two pumps or one pump with multiple independent pumping heads.

In a further alternative embodiment shown in FIG. 6, controller 132 of system 130 is configured to send a control signal to variable frequency or variable speed drive 134 controlling one or more motors 136 for fans, pumps or other equipment. Other components of system 130 unless otherwise stated are generally as described above in connection with schematic monitoring system 10, shown in FIG. 1. In an embodiment such as system 130, gas sample sources A1 and A2 may represent two branches from source piping 64 of a common gas source. The arrangement of system 130 allows for continuous or near continuous sensing of contaminants in the gas supplied through source piping 64. For example, controller 132 may first activate selector valve 16a corresponding to gas sample source branch A1 to sample gas source A1, while selector valve 16b corresponding to gas sample source branch A2 is set to deliver atmospheric air for recovery of its associated sensor/probe. Thus, by cycling the sampling back and forth between gas sample source branches A1 and A2, each sensor/probe has an appropriate sensing time and recovery time permitting continuous or near continuous sensing while allowing recovery. As will be appreciated by persons of ordinary skill, more than two sensors may be used to achieve an appropriate recovery time for each sensor relative to its required active time. As will also be appreciated, the same arrangement of multiple sensors may be effected with a single air intake 14 and/or with a single sampling inlet 12 with appropriate selector valves under control of controller 132 as may be configured by persons of ordinary skill based on the teachings of the present disclosure.

As will be appreciated by persons of ordinary skill in the art, the embodiment shown in FIG. 5 may also be configured with two gas sample inputs from the source piping as in FIG. 6, or, alternatively, the embodiment shown in FIG. 6 may also be configured with a gas sample input from source piping 64 and gas sample input from outlet piping 66 as in FIG. 5.

Further features and advantages of embodiments disclosed herein include:
A way for continuous measuring of gas stream contaminants, and self-cleaning of the sensor/probe to extend its service life.
A system that can monitor the level of incoming air contaminants and odorous compounds and adjust the speed of the treatment system fan accordingly.
A system that can be added to existing systems to significantly increase energy efficiency while maintaining proper air treatment.
A system that can be added to a new treatment equipment order to significantly increase energy efficiency while maintaining proper air treatment.

The foregoing has been a detailed description of illustrative embodiments of the disclosure. It is noted that in the present specification and claims appended hereto, conjunctive language such as is used in the phrases “at least one of X, Y and Z” and “one or more of X, Y, and Z,” unless specifically stated or indicated otherwise, shall be taken to mean that each item in the conjunctive list can be present in any number exclusive of every other item in the list or in any number in combination with any or all other item(s) in the conjunctive list, each of which may also be present in any number. Applying this general rule, the conjunctive phrases in the foregoing examples in which the conjunctive list consists of X, Y, and Z shall each encompass: one or more of X; one or more of Y; one or more of Z; one or more of X and one or more of Y; one or more of Y and one or more of Z; one or more of X and one or more of Z; and one or more of X, one or more of Y and one or more of Z.

Various modifications and additions can be made without departing from the spirit and scope of this disclosure. Features of each of the various embodiments described above may be combined with features of other described embodiments as appropriate in order to provide a multiplicity of feature combinations in associated new embodiments. Furthermore, while the foregoing describes a number of separate embodiments, what has been described herein is merely illustrative of the application of the principles of the present disclosure. Additionally, although particular methods herein may be illustrated and/or described as being performed in a specific order, the ordering is highly variable within ordinary skill to achieve aspects of the present disclosure. Accordingly, this description is meant to be taken only by way of example, and not to otherwise limit the scope of this disclosure or of the inventions as set forth in following claims.

The status of the claims of the current application stands as follows:

1. A gas monitoring system, comprising a gas command circuitry and a decision logic configured to perform at least one of self-cleaning or decontamination for an electrochemical gas sensor communicating with the gas command circuitry.

2. The gas monitoring system of claim 1, further comprising:
at least one selector valve configured to select between a gas sample inlet and an air inlet to provide a sample input stream selectively comprising the gas sample or air;
at least one gas sensor receiving the sample input stream; and
a decision logic configured to switch the sample input stream from the gas sample to the air after a first parameter is met and to switch sample input stream from the air to the gas sample after a second parameter is met.

3. The gas monitoring system of claim 2, wherein the first parameter is a first predefined time period and the second parameter is a second predefined time period.

4. The gas monitoring system of claim 2, further comprising a pump disposed in the sample input stream between the selector valve and gas sensor.

5. The gas monitoring system of claim 2, wherein:
the gas sample inlet is disposed in at least one of a source piping or outlet piping of a gas treatment unit operatively controlled by a treatment system controller; and
the treatment system controller executes the decision logic.

6. The gas monitoring system of claim 5, further comprising:
a first gas sample inlet disposed in said source piping and a second gas sample inlet disposed in said outlet piping;
a first selector valve configured to select between the first gas sample inlet and an air inlet forming a first sample input stream and a second selector valve configured to select between the second gas sample inlet and an air inlet forming a second sample input stream; and
a first gas sensor receiving the first sample input stream and a second gas sensor receiving the second sample input stream.

7. The gas monitoring system of claim 6, wherein:
said first and second gas sensors communicate with the treatment system controller;
the treatment system receives signals from the first and second gas sensors indicative of a measured gas contaminant level in the source piping and outlet piping, respectively; and
the treatment system controller adjusts treatment system operating parameters in response to the received gas contaminant level signals.

8. The gas monitoring system of claim 5, further comprising:
a first gas sample inlet disposed in said source piping and a second gas sample inlet disposed in said source piping; and
a first selector valve configured to select between the first gas sample inlet and an air inlet forming a first sample input stream and a second selector valve configured to select between the second gas sample inlet and an air inlet forming a second sample input stream.

9. The gas monitoring system of claim 8, further comprising a first gas sensor receiving the first sample input stream and a second gas sensor receiving the second sample input stream.

10. The gas monitoring system of claim 9, wherein the decision logic controls the first and second selector valves to provide a gas sample to one said gas sensor when air is provided to the other said gas sensor.

11. The gas monitoring system of claim 2, wherein the gas sensor comprises an electrochemical gas sensor having a detector element disposed in a measuring chamber.

12. A gas monitoring system for continuous gas contaminant monitoring in a gas treatment system having a gas treatment unit communicating with a contaminated gas source and outputting a treated gas, said monitoring system comprising:
at least first and second sample gas streams receiving a gas sample from at least one of the contaminated gas source and the treated gas output;
at least first and second selector valves, each communicating with one said gas sample stream, said selector valves each configured to select between the gas sample stream and an air stream to provide at least first and second sample input streams each selectively comprising the gas sample or air; and
at least first and second gas sensors, each receiving one said sample input stream; and
a decision logic configured to control said selector valves to switch the sample input stream from gas sample to the air after a first parameter is met and to switch from the air to the gas sample after a second parameter is met.

13. The gas monitoring system of claim 12, wherein the first parameter is a first predefined time period and the second parameter is a second predefined time period.

14. The gas monitoring system of claim 12, wherein:
the first gas sample stream is received from the contaminated gas source;
the second gas sample stream is received from the treated gas output;
said first and second gas sensors communicate with the treatment system controller;
the treatment system receives signals from the first and second gas sensors indicative of a measured gas contaminant level in the contaminated gas source and the treated gas output, respectively; and
the treatment system controller adjusts treatment system operating parameters in response to the received gas contaminant level signals.

15. The gas monitoring system of claim 12, wherein:
the first and second gas sample streams are received from the contaminated gas source; and
the decision logic controls the first and second selector valves to provide a gas sample stream to one said gas sensor when air is provided to the other said gas sensor.

16. A gas monitoring method, comprising:
providing an input stream to a gas sensor;
selectively switching the input stream between a gas sample stream and a cleaning air stream, wherein:
the input stream is switched from the gas sample stream to the cleaning air stream based on a first parameter, and
the input stream is switched from the cleaning air stream to the gas sample stream based on a second parameter;
detecting a gas contaminant in the gas sample stream with the gas sensor; and
cleaning the gas sensor with the cleaning air stream.

17. The gas monitoring method of claim 16, wherein at least one of the first and second parameters is time.

18. The gas monitoring method of claim 16, wherein the first time parameter is a user defined time period and the second time parameter is a time period corresponding to a time required to clean the gas sensor.

19. The gas monitoring method of claim 16, wherein said providing an input stream comprises providing a first input stream to a first gas sensor and providing a second input stream to a second gas sensor.

20. The gas monitoring method of claim 19, wherein:
the gas sample stream for the first input stream is provided from a contaminated gas source and the gas sample stream for the second input stream is also provided from the contaminated gas source; and
said selectively switching comprises providing the gas sample stream to one said input stream while providing the cleaning air stream the other said input stream.

21. The gas monitoring method of claim 19, wherein:
the gas sample stream for the first input stream is provided from a contaminated gas source for a contaminated gas treatment system;
the gas sample stream for the second input stream is provided from a treated gas output of the contaminated gas treatment system;
said detecting gas contaminant comprises detecting a level of gas contaminant in the contaminated gas source and detecting a level of gas contaminant in the treated gas output; and
controlling operation of the gas treatment system at least in part based on a differential between the detected gas contaminant level in the contaminated gas source and the detected gas contaminant level in the treated gas output.

22. A gas sensor cleaning kit for retrofitting an existing gas monitoring system having a gas sensor receiving a sample input stream from a contaminated gas source of a gas, said kit comprising:
a selector valve configured to be disposed in the sample stream to selectively switch between the gas sample stream and a cleaning air stream; and
a decision logic configured to switch the selector valve from the gas sample input stream to the air input stream after a first parameter is met and to switch the air input stream to the gas sample input stream after a second parameter is met.

23. The gas sensor cleaning kit of claim 22, wherein the first parameter is a user defined first time period and the second parameter is a second time period corresponding to the time for cleaning the gas sensor with the cleaning air stream.

24. The gas sensor cleaning kit of claim 22, further comprising a gas pump configured to be disposed in the gas sample stream downstream of the selector valve.

25. The gas sensor cleaning kit of claim 22, further comprising a cleaning air inlet and at least sufficient piping to connect the cleaning air inlet to the selector valve.
